(19) United States
(12) Patent Application Publication
(10) Pub. No.: US 2014/0362371 A1
(43) Pub. Date: Dec. 11, 2014

(54) SENSOR FOR MEASURING SURFACE NON-UNIFORMITY

(71) Applicant: 3M INNOVATIVE PROPERTIES COMPANY, St. Paul, MN (US)

(72) Inventors: Yi Qiao, Santa Clara, CA (US); Jack W. Lai, Lake Elmo, MN (US); Evan J. Ribnick, St. Louis Park, MN (US); David L. Hofeldt, Oakdale, MN (US)

(21) Appl. No.: 14/366,399

(22) PCT Filed: Dec. 11, 2012
(86) PCT No.: PCT/US2012/068935

§ 371 Date: Jun. 18, 2014

Related U.S. Application Data
(60) Provisional application No. 61/578,174, filed on Dec. 20, 2011.

(51) Int. Cl. G01B 11/30; G01N 21/95

(52) U.S. Cl. CPC G01B 11/303; G01N 21/95; G01N 2201/12; G01N 2201/06113
USPC 356/237.2

(57) ABSTRACT

A method includes forming a two-dimensional interrogating beam on a selected sample region of a surface; collecting light transmitted through or reflected from the sample region with an array of lenses to form a sample array of focus spots; imaging the sample array of focus spots through an imaging lens on a sensor; and comparing an image of the sample array of focus spots to a reference array of focus spots to determine a level of non-uniformity in the sample region.

### CROSS REFERENCE TO RELATED APPLICATIONS

This application claims the benefit of U.S. Provisional Application No. 61/578,174, filed Dec. 20, 2011, the disclosure of which is incorporated by reference herein in its entirety.

### TECHNICAL FIELD

The present disclosure relates to material inspection systems, such as computerized systems for the inspection of moving webs of material.

### BACKGROUND

Under ideal conditions, a production line could produce a product that is perfectly uniform and devoid of variability. However, process variables and material formulation errors can cause product non-uniformity in real-world manufacturing. For example, if a sheet of a web-like polymeric material is intended for use in a display of a computer or a mobile device, distortion or waviness defects occurring during manufacture can strongly affect a customer's visual perception of the product.

Imaging-based inspection systems have been used to monitor the quality of a manufactured product as it proceeds through the manufacturing process. The inspection systems capture digital images of a selected part of the product material using sensors such as, for example, CCD cameras. Processors in the inspection systems apply algorithms to rapidly evaluate the captured digital images of the sample of material to determine if the sample, or a selected region thereof, is suitably defect-free for sale to a customer.

The inspection systems can identify “point” defects in which each defect is localized to a single area of the manufactured material. However, a web of material may include large areas of non-uniformity, and such defects may include, for example, mottle, chatter, banding, streaks and distortion. These distributed and non-localized defects can be more difficult for computerized inspection systems to detect and quantify than localized, point defects.

### SUMMARY

In one aspect, the present disclosure is directed to a method that includes forming a two-dimensional interrogating beam on a selected sample region of a surface. Light is transmitted through or reflected from the sample region with an array of lenses to form a sample array of focus spots. The sample array of focus spots is imaged on a sensor through an imaging lens, which can be a single element lens or multiple element lens combination, hereafter referred as an imaging lens for simplicity. An image of the sample array of focus spots is compared to a reference array of focus spots to determine a level of non-uniformity in the sample region.

In another aspect, the present disclosure is directed to an apparatus including at least one light source that forms a two-dimensional interrogating beam on a selected sample region of a surface; a lenslet array that captures light transmitted through or reflected from the sample region of the surface to form a sample array of focus spots; an imaging lens that images the sample array of focus spots produced by the lenslet array on a sensor; and a processor that determines, relative to a reference array of focus spots, at least one of the following variations: (1) the displacement in an X-Y plane of a focus spot in the sample array, (2) a size of a focus spot in the sample array, and (3) an intensity of a focus spot in the sample array, wherein the variations are representative of a level of non-uniformity in the sample region.

In another aspect, the present disclosure is directed to a system for monitoring the distortion within a selected sample region on a surface of a material. The system includes a light source that forms a two-dimensional interrogating beam on the selected sample region of the surface; a lenslet array that captures light transmitted through or reflected from the sample region of the surface to form a sample array of focus spots; an imaging lens to image the sample array of focus spots on a sensor; and a processor that measures, relative to a reference array of focus spots, at least one of the displacement in an X-Y plane, the size, and the intensity of the focus spots in the sample array, to determine the level of non-uniformity in the sample region.

In yet another aspect, the present disclosure is directed to a method that includes positioning a light source proximal to a surface of a non-stationary web of a flexible material, wherein the light source forms a two-dimensional interrogating beam on a selected sample region of the surface. Light transmitted through the sample region is collected by a lenslet array, wherein the lenslet array forms a corresponding sample array of focus spots. The sample array of focus spots is imaged through an imaging lens on a sensor of a camera. The image on the sensor is processed to measure, relative to a reference array of focus spots, a displacement in the X-Y direction of each focus spot in the sample array, and computing the non-uniformity in the sample region based on the measured displacements of the focus spots.

In yet another aspect, the present disclosure is directed to a method for inspecting web material in real time and computing a distortion level of a selected sample region in a surface of the web material as the web material is manufactured. The method includes positioning a light source proximal to a surface of a non-stationary web of a flexible material, wherein the light source forms a two-dimensional interrogating beam on a selected sample region of the surface. Light transmitted through the sample region is collected by a lenslet array, wherein the lenslet array forms a corresponding sample array of focus spots. The sample array of focus spots is imaged through an imaging lens on a sensor of a camera; and the image on the sensor is processed to measure, relative to a reference array of focus spots, a displacement in the X-Y direction of each focus spot in the sample array. The level of non-uniformity in the sample region is then computed based on the measured displacements.

In yet another aspect, the present disclosure is directed to an online computerized inspection system for inspecting web material in real time. The system includes a light source that forms a two-dimensional interrogating image on the selected sample region of the surface; a lenslet array that captures light transmitted through the sample region of the surface to form a sample array of focus spots; an imaging lens to image the sample array of focus spots on a sensor; and a computer executing software to determine the level of non-uniformity in the sample region based on a measured variation, relative to a reference array of focus spots, of each focus spot in the sample array.

In yet another aspect, the present disclosure is directed to a non-transitory computer readable medium including software instructions to cause a computer processor to receive, with an online computerized inspection system, an image of a measured sample array of focus spots of one or more sample regions on a surface of a web material during the manufacture thereof, compare the image of the sample array of focus spots with a reference array of focus spots ; and compute the severity of a non-uniformity defect in the web material based on the variation between the focus spots in the sample array and the reference array.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A and 1B are schematic illustrations of a method and apparatus used to measure point defects in a surface of a material.

FIG. 2 is a schematic illustration of an embodiment of a sensor for measuring a non-uniformity of a sample region of a surface.

FIG. 3 is a flowchart illustrating an embodiment of a method for measuring the level of non-uniformity in a sample region of a material.

FIG. 4 is a schematic block diagram of an exemplary embodiment of an inspection system in an exemplary web manufacturing plant.

FIG. 5 is an image of a reference array of focus spots used in the Example.

FIG. 6 is an image of a sample array of focus spots used in the Example.

FIG. 7 is a surface contour map of the image data of FIG. 6.

Like symbols in the drawings can indicate like elements.

### DETAILED DESCRIPTION

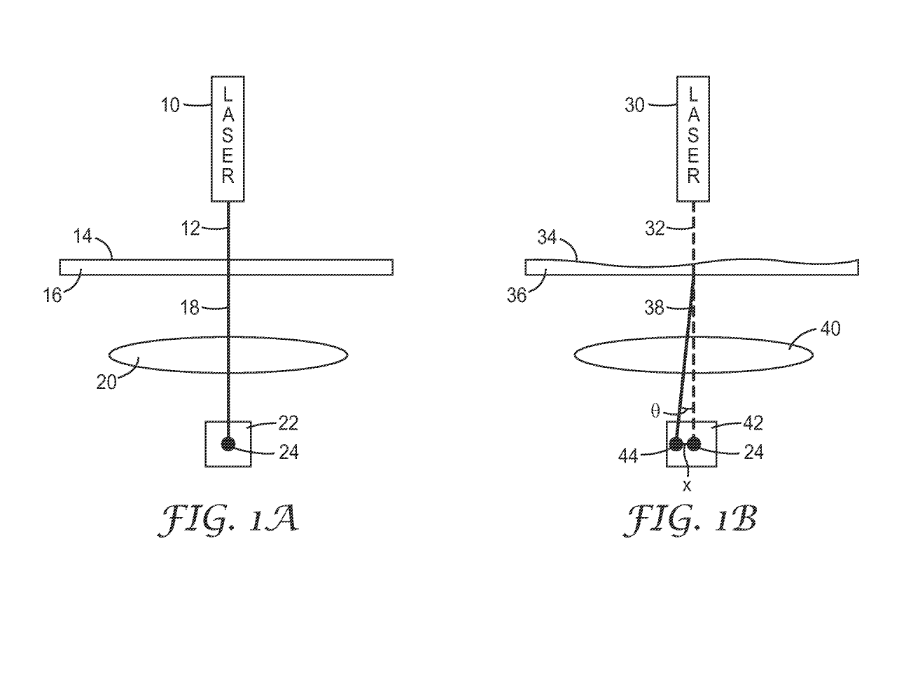

One method that may be used to measure a defect in a manufactured material is shown in FIGS. 1A and 1B. Referring to FIG. 1A, a light source 10 such as, for example, a laser, projects an interrogating light beam 12 onto a reference surface 14 of a reference sample material 16. The reference surface 14 is substantially flat and free of non-uniformity defects such as distortion, banding, streaks and the like. A light beam 18 transmitted through the sample material 16 passes through a Fourier Transform lens 20 and is imaged on a sensor 22. The beam 18 forms a reference focus spot 24 on the sensor 22 that is characteristic of the angular alignment of the light source 10, the lens 20, and the reference surface 14. A selected characteristic of the reference focus spot 24 such as, for example, the location of the spot in an X-Y plane, is then stored in the memory of a computer (not shown in FIG. 1A).

Referring to FIG. 1B, a light source 30 projects an interrogating light beam 32 onto a surface 34 of a sample material 36. The surface 34 is includes at least one non-uniformity defect such as, for example, distortion, banding, streaks and the like. A light beam 38 transmitted through the sample material 36 passes through the Fourier Transform lens 40 and is projected onto a sensor 42. The beam 38 forms a focus spot 44 on the sensor 42 that is characteristic of the surface 34 of the sample material 36.

If the selected characteristics of the focus spot 44 on the sensor 42 are compared to the characteristics of the reference spot 24 stored in memory, the non-uniformity defect in the surface 34 will cause a measurable change in the focus spot 44. For example, certain non-uniformity defects in the surface 34 will cause an angular deviation θ of the light beam 38 and a corresponding linear deviation x between the centers of the focus spots 24 and 44.

The method and apparatus shown in FIGS. 1A-1B provide only a one-point measurement of the surface characteristics of the sample material. To measure a non-uniformity defect over a large sample region on a surface of a material, the laser beam can be scanned across a selected part of the sample region, which is time consuming and can make it difficult to rapidly evaluate the surface characteristics of the sample region in real-time as the material is manufactured.

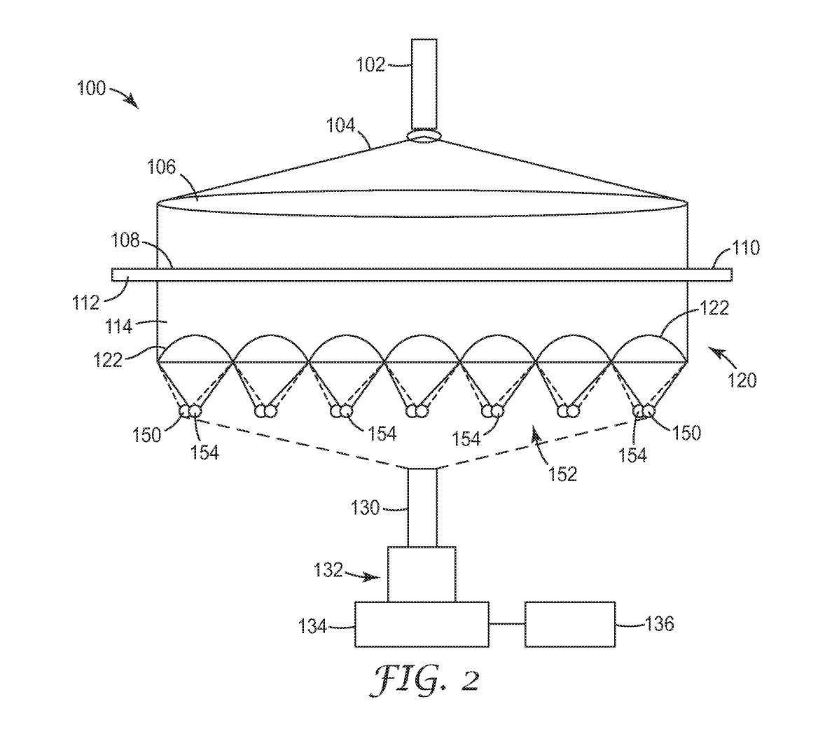

Referring to FIG. 2, a system and apparatus for measuring surface non-uniformity 100 includes at least one light source 102 that emits an interrogating light beam 104. Suitable light sources 102 may vary widely depending on the type of surface to be analyzed, but light sources with well defined wavefronts, such as lasers, are particularly preferred, and suitable lasers include He-Ne lasers, diode lasers and the like.

The interrogating light beam 104 passes through an optional lens system 106 that further expands the beam to overlie a selected sample region 108 on a surface 110 of a sample material 112. If multiple interrogating light beams 104 are used as the light source 102, the lens system 106 may not be necessary to sufficiently expand the beams to overlie the sample region 108.

For example, the analysis method and apparatus described herein are particularly well suited, but are not limited to, inspecting the surface of web-like rolls of sample materials 112. In general, the web rolls may contain a manufactured web material that may be any sheet-like material having a fixed dimension in one direction (cross-web direction) and either a predetermined or indeterminate length in the orthogonal direction (down-web direction). Examples of web materials that can be effectively analyzed using the system 100 include, but are not limited to, transmissive or reflective sample materials 112 in which the surface 110 is not highly scattering to the light emitted by the light source 102. Examples include metals, paper, wovens, non-wovens, glass, polymeric films, flexible circuits or combinations thereof. Metals may include such materials as steel or aluminum. Woven materials generally include various fabrics. Non-wovens include materials, such as paper, filter media, or insulating material. Films include, for example, clear and opaque polymeric films including laminates and coated films.

The surface 110 includes non-uniformities such as, for example, mottle, chatter, banding, streaks and distortion (not shown in FIG. 2), which may extend over broad areas of the sample material 112. The light source 102 and the lens system 106 may be selected to provide a suitably sized sample region 108 for a particular surface analysis application.

A two-dimensional light beam 114 is transmitted through and/or reflected off the surface 110 of the sample material 112 and is thereafter made incident on an array of lenses 120. The lens array 120, which may be linear or two-dimensional, includes a suitable number and arrangement of lens elements 122, which may be referred to herein as lenslets, to capture at least a portion of the transmitted or reflected light beam 114. While the lens array 120 can be any suitable size and shape, the size and shape of the lens array 120 is preferably selected such that all the lenslets 122 in the lens array 120 are filled by the transmitted light beam 114. If multiple transmitted light beams 114 are utilized as the light source 102, the lenslets in the lens array 120 are preferably arranged such that the combination of angular divergence from the lens system 106 (if present) and the amount of angular deviation caused by the sample material 112 do not cause multiple transmitted light beams to be incident on a single lenslet or to be incident in a region between lenslets. Multiple lens arrays 120 may optionally be placed adjacent to one another to match the size of the transmitted light beam 114.

Each of the lenslets 122 includes a curved surface selected to produce a focus spot 150, and the two-dimensional array of focus spots 152 produced by the lens array 120 is characteristic of the features in the sample region 108 of the surface 110. In the embodiment shown in FIG. 2, the array of focus spots 152 is imaged by an imaging lens system 130 onto a suitable sensor system 132 including for example, a CCD or CMOS camera 134.

The sensor system 132 includes a processor 136, which may be internal, external or remote from the camera 134. The processor 136 includes a reference array of focus spots 154 stored in memory. The reference array of focus spots 154 results from prior analysis using the apparatus 100 of a reference sample material 112 that is substantially free of non-uniformity defects, or may be calculated based on a theoretical model of the behavior of an ideal sample material.

A non-uniformity defect in any portion of the sample region 108 causes a change in the light transmitted through that portion of the sample material 112, which is collected by the underlying lenslets 122 in the lenslet array 120. For example, non-uniformity defects in the sample region 108 can cause angular deflection, angular divergence, or altered transmittance of the interrogating light beam. These alterations can result in, relative to a reference array of focus spots, a change in at least one of: (1) the location of the focus spots in an X-Y plane, (2) the size of the focus spots, or (3) the intensity of the focus spots.

In the embodiment shown in FIG. 2, an angular deflection of the interrogating beam 114 is detected by at least some of the lenslets 122 underlying the sample region 108, which causes a corresponding displacement in at least one of the X and Y directions between the focus spots 150 in the array 152, when compared to the reference array of focus spots 154 stored in the memory of the processor 136. The processor 136 utilizes any suitable algorithm to compare the location in the X-Y plane of each focus spot 150 in the two-dimensional array 152 to the location of its corresponding reference focus spot 154 in the reference focus spot array. This linear displacement between the centroid regions of the focus spots 150, 154 produced by each lenslet 122 in the lens array 120 is proportional to the severity of the non-uniformity defect in the corresponding overlying area of the sample region 108.

Compared to the point measurement apparatus shown in FIGS. 1A-1B, the apparatus of FIG. 2 simultaneously measures multiple points to enable rapid two-dimensional mapping of non-uniformity over a large sample region 108. The two-dimensional map of the array of the focus spots 150 is a true representation of sample uniformity in two directions (for example, in a web material, in the cross and down-web directions). In addition, the displacement of the two-dimensional array of the focus spots 150 from the reference array of focus spots 154 is relatively simple to process and interpret using algorithms in the processor 136.

The sensitivity of the apparatus 100 is primarily determined by two factors: 1) the focal length of the lenslets 122 in the lens array 120 (the longer the focal length of the lenslets 122, the higher the sensitivity); and 2) the resolution of the sensor system 132 and imaging processing algorithm in the processor 136 used to track the centroid shift between the focus spots 150 and 154. For example, if a centroid of a spot falls across more than a single pixel on the sensor of the camera 134, the processor 136 calculates the centroid of the intensities of pixels that lie within the spot. The angular range of the system is then determined by how many pixels remain before impacting the region of pixels that subtend an adjacent lenslet in the array.

In the apparatus 100, an array of cylindrical lenses or a lenticular lens array may be used to replace the lens array, and a line scan camera may be used to replace the CCD or CMOS camera. However, this alternative embodiment only allows a non-uniformity measurement in one direction (for, example, across a web).

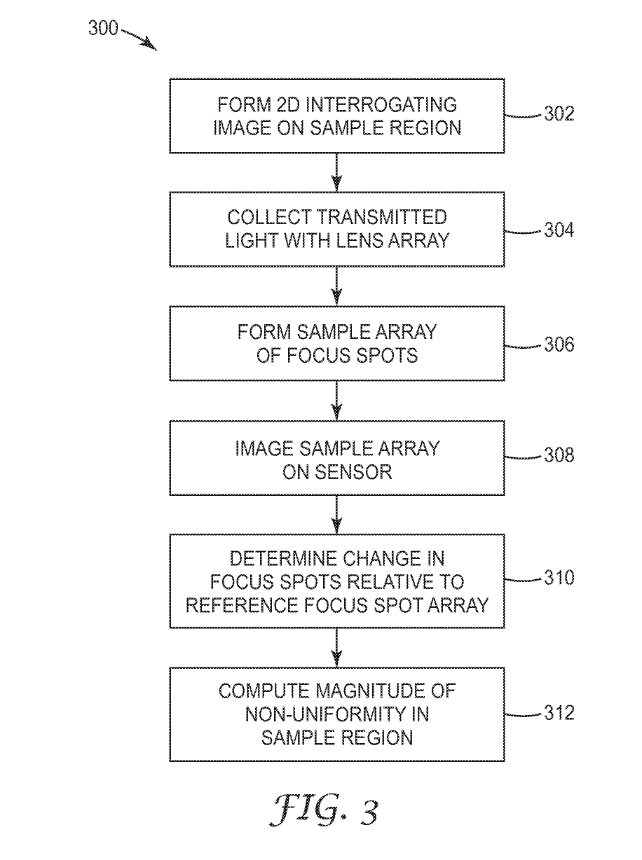

FIG. 3 is a flowchart illustrating a method 300 of operating the apparatus in FIG. 2 to determine the level of non-uniformity in a sample region of a material. In step 302, an output beam of at least one light source forms a two-dimensional interrogating beam on a selected sample region of a surface. In steps 304 and 306, the light transmitted through or reflected from the sample region is collected by an array of lenses to form a corresponding sample array of focus spots. In step 308, the sample array of focus spots is imaged on a sensor such as a CCD camera. In step 310, the image of the sample array on the sensor is processed to determine a selected variation in a selected focus spot characteristic relative to a reference focus spot array. Examples of measurable variations in focus spot characteristics include, but are not limited to, differences in spot location, spot size, or spot intensity. In step 312, the variations are used to evaluate and/or characterize the non-uniformity in the sample region.

In some embodiments, the apparatus of FIG. 2 may be utilized in one or more inspection systems to inspect web materials during manufacture. To produce a finished web roll that is ready for conversion into individual sheets for incorporation into a product, unfinished web rolls may undergo processing on multiple process lines either within one web manufacturing plant, or within multiple manufacturing plants. For each process, a web roll is used as a source roll from which the web is fed into the manufacturing process. After each process, the web is typically collected again into a web roll and moved to a different product line or shipped to a different manufacturing plant, where it is then unrolled, processed, and again collected into a roll. This process is repeated until ultimately a finished web roll is produced. For many applications, the web materials for each of the web rolls may have numerous coatings applied at one or more production lines of the one or more web manufacturing plants. The coating is generally applied to an exposed surface of either a base web material, in the case of a first manufacturing process, or a previously applied coating in the case of a subsequent manufacturing process. Examples of coatings include adhesives, hardcoats, low adhesion backside coatings, metalized coatings, neutral density coatings, electrically conductive or nonconductive coatings, or combinations thereof.

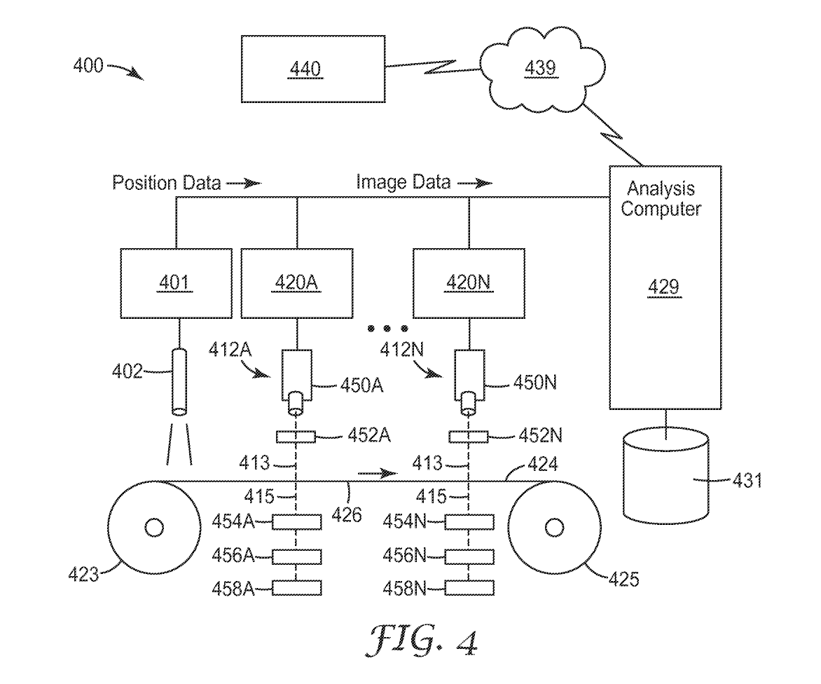

In the exemplary embodiment of an inspection system 400 shown in FIG. 4, a sample region of a web 426 is positioned between two support rolls 423, 425. The inspection system 400 includes a fiducial mark controller 401, which controls fiducial mark reader 402 to collect roll and position information from the sample region 426. In addition, the fiducial mark controller 401 may receive position signals from one or more high-precision encoders engaged with selected sample region of the web 426 and/or support rollers 423, 425. Based on the position signals, the fiducial mark controller 401 determines position information for each detected fiducial mark. The fiducial mark controller 401 communicates the roll and position information to an analysis computer 429 for association with detected data regarding the dimensions of features on a surface of the web 424.

The system 400 further includes one or more optical imaging systems 412A-412N, which each include a laser light source 450 and a beam expanding lens system 452. The optical systems 412 are positioned in close proximity to a surface 424 of the continuously moving web of material 426 as the web is processed, and scan sequential sample areas of the continuously moving web 426 to obtain digital image data.

The optical systems 412 project a light beam into beam expanding optics 452 to produce an interrogating beam 413 onto a sample region of 426 the web surface 424. The light 415 transmitted through the sample region of the web 426 is collected by a lens array 454. The lens array 454 produces a sample array of focus spots, which is collected by an imaging lens system 456 and imaged onto a sensor system 458.

An image data acquisition computer 427 collects image data from the sensor systems 458 and transmits the image data to an analysis computer 429. The analysis computer 429 processes streams of image data from the image acquisition computers 427 and analyzes the digital images with one or more algorithms to compare the sample array of focus spots to a reference array of focus spots stored in memory. The computer evaluates the variation in each focus spot in the sample array with respect to its corresponding focus spot in the reference array to compute the level of non-uniformity in the sample region of the web material 426. The analysis computer 429 may display the results on an appropriate user interface and/or may store the results in a database 431.

The inspection system 400 shown in FIG. 4 may be used within a web manufacturing plant to apply algorithms for detecting the presence of non-uniformity defects in the web surface 424. The inspection system 400 may also provide output data that indicates a severity of each defect in real-time as the web is manufactured. For example, the computerized inspection systems may provide real-time feedback to users, such as process engineers, within web manufacturing plants regarding the presence of non-uniformities and their severity, thereby allowing the users to quickly respond to an emerging non-uniformity in a particular batch of material or series of batches by adjusting process conditions to remedy a problem without significantly delaying production or producing large amounts of unusable material. The computerized inspection system 400 may apply algorithms to compute the severity level by ultimately assigning a rating label for the non-uniformity (e.g., “good” or “bad”) or by producing a measurement of non-uniformity severity of a given sample on a continuous scale or more accurately sampled scale.

The analysis computer 429 may store the non-uniformity rating or other information for the sample region of the web 426, including roll identifying information for the web 426 and possibly position information for each measured feature, within the database 431. For example, the analysis computer 429 may utilize position data produced by fiducial mark controller 401 to determine the spatial position or image region of each measured area of non-uniformity within the coordinate system of the process line. That is, based on the position data from the fiducial mark controller 401, the analysis computer 429 determines the x, y, and possibly z position or range for each area of non-uniformity within the coordinate system used by the current process line. For example, a coordinate system may be defined such that the x dimension represents a distance across web 426, a y dimension represents a distance along a length of the web, and the z dimension represents a height of the web, which may be based on the number of coatings, materials or other layers previously applied to the web. Moreover, an origin for the x, y, z coordinate system may be defined at a physical location within the process line, and is typically associated with an initial feed placement of the web 426.

The database 431 may be implemented in any of a number of different forms including a data storage file or one or more database management systems (DBMS) executing on one or more database servers. The database management systems may be, for example, a relational (RDBMS), hierarchical (HDBMS), multidimensional (MDBMS), object oriented (ODBMS or OODBMS) or object relational (ORDBMS) database management system. As one example, the database 431 is implemented as a relational database available under the trade designation SQL Server from Microsoft Corporation, Redmond, Wash.

Once the process has ended, the analysis computer 429 may transmit the data collected in the database 431 to a conversion control system 440 via a network 439. For example, the analysis computer 429 may communicate the roll information as well as the feature dimension and/or anomaly information and respective sub-images for each feature to the conversion control system 440 for subsequent, offline, detailed analysis. For example, the feature dimension information may be communicated by way of database synchronization between the database 431 and the conversion control system 440.

In some embodiments, the conversion control system 440 may determine those products of products for which each anomaly may cause a defect, rather than the analysis computer 429. Once data for the finished web roll has been collected in the database 431, the data may be communicated to converting sites and/or used to mark anomalies on the web roll, either directly on the surface of the web with a removable or washable mark, or on a cover sheet that may be applied to the web before or during marking of anomalies on the web.

The components of the analysis computer 429 may be implemented, at least in part, as software instructions executed by one or more processors of the analysis computer 429, including one or more hardware microprocessors, digital signal processors (DSPs), application specific integrated circuits (ASICs), field programmable gate arrays (FPGAs), or any other equivalent integrated or discrete logic circuitry, as well as any combinations of such components. The software instructions may be stored within in a non-transitory computer readable medium, such as random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media.

Although shown for purposes of example as positioned within a manufacturing plant, the analysis computer 429 may be located external to the manufacturing plant, e.g., at a central location or at a converting site. For example, the analysis computer 429 may operate within the conversion control system 440. In another example, the described components execute on a single computing platform and may be integrated into the same software system.

The subject matter of the present disclosure will now be described with reference to the following non-limiting example.

### EXAMPLE

An apparatus of FIG. 2 was prepared, and the beam 104 emitted by the laser 102 was expanded by a lens system 106 to cover an area of about 2.25 square inches. As lenslet array 120 having an area of about 4 square inches captured the light transmitted through the sample area 108 of the sample material 112, and a sample array of focus spots 152 was imaged to a CCD camera 134 via an imaging lens system 130.

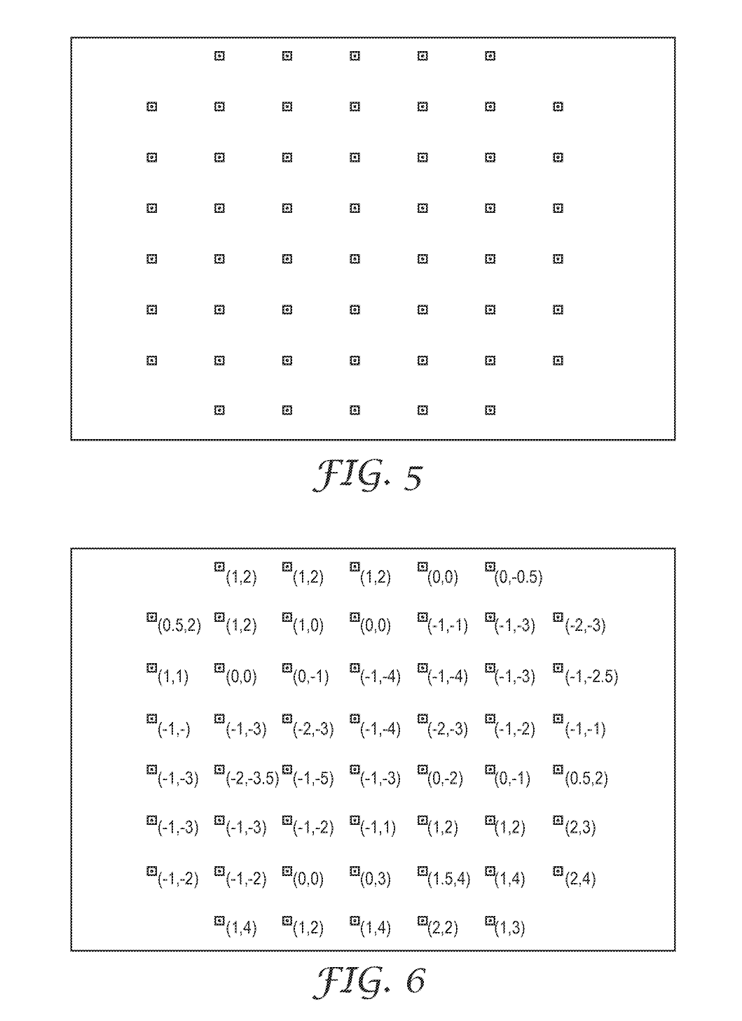

FIG. 5 shows an image of a reference array of focus spots 154, and FIG. 6 shows the shifted sample array of focus spots 150 created when a non-uniform sample of material is placed between the expanded laser beam and the lenslet array 120. The numerical values listed in FIG. 6 are the X and Y displacements of the image of the sample array of focus spots 150 with respect to the image of reference array of focus spots 154.

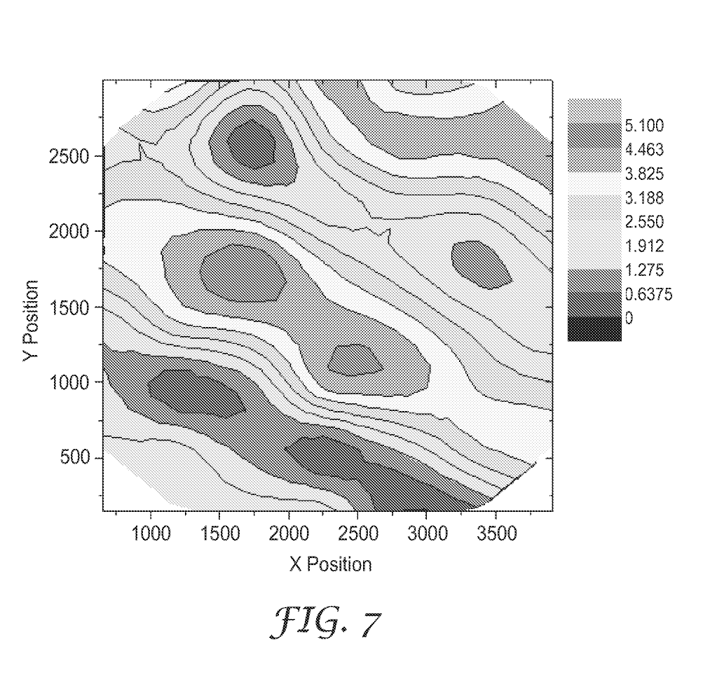

FIG. 7 is a surface contour map of the web distortion amplitude calculated from data shown in FIG. 6. Other information such as the web slope direction can be obtained as well.

Various embodiments of the invention have been described. These and other embodiments are within the scope of the following claims.

1. A method, comprising:
forming a two-dimensional interrogating beam on a selected sample region of a surface;
collecting light transmitted through or reflected from the sample region with an array of lenses to form a sample array of focus spots;
imaging the sample array of focus spots through an imaging lens on a sensor; and
comparing an image of the sample array of focus spots to a reference array of focus spots to determine a level of non-uniformity in the sample region, optionally wherein the light source comprises a laser.

2. (canceled)

3. The method of claim 1, wherein an output beam of a single light source is expanded by at least one beam expanding lens to form the two-dimensional interrogating beam.

4. The method of claim 1, wherein the two-dimensional interrogating beam is formed by multiple light sources.

5-8. (canceled)

9. The method of claim 3, wherein the sensor comprises a CCD or a CMOS camera, and further wherein the sample is a moving web of material.

10. The method of claim 1, wherein the comparing step compares at least one of the following characteristics of the focus spots in the sample array to that of the focus spots in the reference array: displacement in an X-Y plane, size and intensity.

11. The method of claim 1, wherein the comparing step compares a displacement in an X-Y plane of the focus spots in the sample array relative to the locations of the focus spots in the reference array.

12. The method of claim 1, wherein the collected light is transmitted through the sample region.

13. An apparatus, comprising:
at least one light source that forms a two-dimensional interrogating beam on a selected sample region of a surface;
a lenslet array that captures light transmitted through or reflected from the sample region of the surface to form a sample array of focus spots;
an imaging lens that images the sample array of focus spots produced by the lenslet array on a sensor; and
a processor that determines, relative to a reference array of focus spots, at least one of the following variations in a characteristic of the sample array of focus spots: (1) the displacement in an X-Y plane of a focus spot in the sample array, (2) a size of a focus spot in the sample array, and (3) an intensity of a focus spot in the sample array, wherein the variations are representative of a level of non-uniformity in the sample region, optionally wherein the light source is a laser.

14. The apparatus of claim 13, wherein the processor determines the displacement of a focus spot in the sample array relative to the reference array of focus spots.

15. The apparatus of claim 13, further comprising a beam expanding lens between the light source and the surface.

16. The apparatus of claim 13, wherein multiple light sources form the interrogating beam.

17. (canceled)

18. The apparatus of claim 13 wherein the imaging lens comprises: (1) a single element lens, or (2) a multiple element lens combination.

19. (canceled)

20. The apparatus of claim 13, wherein the processor is internal to the sensor.

21. The apparatus of claim 13, wherein the processor is remote from the sensor.

22. The apparatus of claim 13, wherein the lenslet array captures light transmitted through the sample region.

23. A system for monitoring the distortion within a selected sample region on a surface of a material, comprising:
a light source that forms a two-dimensional interrogating beam on the selected sample region of the surface;
a lenslet array that captures light transmitted through or reflected from the sample region of the surface to form a sample array of focus spots;
an imaging lens to image the sample array of focus spots on a sensor; and
a processor that measures, relative to a reference array of focus spots, at least one of the displacement in an X-Y plane, the size and the intensity of the focus spots in the sample array to determine the level of non-uniformity in the sample region.

24. The system of claim 23, wherein the processor measures, relative to the reference array, the displacement in the X-Y direction of each focus spot in the sample array.

25. The system of claim 23, wherein the lenslet array captures light transmitted through the surface of the sample region.

26. The system of claim 23, wherein the surface of the material is non-stationary.

27. The system of claim 23, wherein the light source is a laser, and wherein the system further comprises a beam expanding lens between the laser and the surface.

28-42. (canceled)
